(19) United States
(12) Patent Application Publication
(10) Pub. No.: US 2018/0224997 A1
(43) Pub. Date: Aug. 9, 2018

(54) METHOD AND SYSTEM FOR ONE-HANDED OPERATIONS OF MOBILE TERMINAL

(71) Applicant: Huizhou TCL Mobile Communication Co., LTD, Hui Zhou (CN)

(72) Inventor: MINGQIU ZHANG, Hui Zhou (CN)

(21) Appl. No.: 15/749,150

(22) PCT Filed: Dec. 9, 2016
(86) PCT No.: PCT/CN2016/109235

§ 371 Date: Jan. 31, 2018

(30) Foreign Application Priority Data
Jun. 7, 2016 (CN) 201610397588.8

(51) Int. Cl. G06F 3/041; G06F 3/0488

(52) U.S. Cl. CPC G06F 3/0416; G06F 3/0482; G06F 3/04886

(57) ABSTRACT

One-handed operations of a mobile terminal may include displaying, when an instruction to turn on a one-handed operation mode is received, a simulated mouse and a simulated mouse control region on the touchscreen of the mobile terminal; detecting a touch on the touchscreen, and acquiring position information of a touch point; determining, according to the position information of the touch point, whether the touch point is located within the simulated mouse control region, and if so, controlling the simulated mouse to complete a corresponding operation according to the touch information.

### FIELD OF THE INVENTION

The present invention relates to the field of mobile terminal applications, and in particular to a method and system for one-handed operations of a mobile terminal.

### DESCRIPTION OF THE RELATED ART

Big screen smart mobile terminals are increasingly popular, particularly those which meet the size requirements of multimedia. As a portable handheld device, input operations on a smart mobile terminal may be completed by both hands. In some cases, however, a user can only operate with one hand, where one-handed operation is more difficult as the size of the smart mobile terminal becomes bigger due to the size limitation of a user's palm. Therefore, the prior art needs to be further improved and developed.

### SUMMARY OF THE INVENTION

In response to the above deficiencies of the prior art, the present invention provides a method and system for one-handed operations of a mobile terminal to solve the problem that one-handed operations of big screen smart mobile terminals are inconvenient.

The present invention employs the following technical solutions to solve the technical problem:

A method for one-handed operations of a mobile terminal, which comprises:

displaying, when an instruction to turn on a one-handed operation mode is received, a simulated mouse and a simulated mouse control region on a touchscreen of the mobile terminal, said simulated mouse control region being in an operation region of a user's dominant hand, formed by reducing the an input region of the touchscreen, for controlling the simulated mouse to operate the mobile terminal;

detecting a touch on the touchscreen of the mobile terminal, and acquiring position information of a touch point; and

determining, according to the acquired position information of the touch point, whether the touch point is located within the simulated mouse control region, and if so, controlling the simulated mouse to complete a corresponding operation according to the acquired position information of the touch point (touch information).

The method for one-handed operations of a mobile terminal, wherein the step of “displaying, when an instruction to turn on a one-handed operation mode is received, a simulated mouse on the touchscreen of the mobile terminal, and at the same time, displaying a simulated mouse control region within the operation region of a user's dominant hand on the touchscreen for controlling the simulated mouse to operate the mobile terminal” comprises:

determining, when a user instruction to turn on a one-handed operation mode is received, whether it is a first time to turn on said one-handed operation mode;

if so, receiving a user instruction to preset a user's dominant hand and a size of the simulated mouse control region;

if not, displaying the simulated mouse and the simulated mouse control region on the touchscreen.

The method for one-handed operations of a mobile terminal, wherein the “if not, displaying the simulated mouse and the simulated mouse control region on the touchscreen” comprises:

reducing the input region of the cell phone to the size of the simulated mouse control region, and updating a boundary of each region of the simulated mouse control region according to a preset user's dominant hand.

In an embodiment, the method for one-handed operations of a mobile terminal, wherein the simulated mouse control region comprises:

a movement control region for controlling movement, single click and double click operations of the simulated mouse, and for performing multi-point touch control on the region where the simulated mouse is located;

a return region for carrying out operations of a return button of the mobile terminal; and

a menu region for carrying out operations of a menu button of the mobile terminal.

In an embodiment, the method for one-handed operations of a mobile terminal may include, wherein the step of “determining, according to the acquired position information of the touch point, whether the touch point is located within the simulated mouse control region, and if so, controlling the simulated mouse to complete a corresponding operation according to the touch information” comprises:

when the touch point is located within the movement control region of the simulated mouse control region, controlling the simulated mouse to complete movement, single click and double click operations according to the touch information, or performing multi-point touch control on the region where the simulated mouse is located;

when the touch point is located within the return region or the menu region of the simulated mouse control region, correspondingly converting the position information of the touch point to position information of the return button or the menu button for input into the mobile terminal, and controlling the mobile terminal to carry out a corresponding return operation or menu operation.

The method for one-handed operations of a mobile terminal, wherein the step of “when the touch point is located within the movement control region of the simulated mouse control region, controlling the simulated mouse to complete movement, single click and double click operations according to the touch information, or performing multi-point touch control on the region where the simulated mouse is located” comprises:

when the touch point is located within a movement control region of the mouse, transmitting the touch point information to a mouse simulation drive program, and after said program determines a movement, single click or double click event of the mouse, reporting to an input sub-system to simulate a mouse operation event.

In an embodiment, the method for one-handed operations of a mobile terminal may include, wherein the step of “when the touch point is located within the return region or the menu region of the simulated mouse control region, correspondingly converting the position information of the touch point to the position information of the return button or the menu button for input into the mobile terminal, and controlling the mobile terminal to carry out a corresponding return operation or menu operation” comprises:

when the touch point is located within the return region or the menu region, converting the corresponding touch point to a touch point position corresponding to the return button or the menu button, and reporting to the input sub-system.

In an embodiment, the method for one-handed operations of a mobile terminal may include, wherein the operation region of a user's dominant hand comprises:

a right lower region of the touchscreen when the user's dominant hand is the user's right hand, and a left lower region of the touchscreen when the user's dominant hand is the user's left hand.

In an embodiment, the method for one-handed operations of a mobile terminal may include, wherein the step of “determining, according to the acquired position information of the touch point, whether the touch point is located within the simulated mouse control region, and if so, controlling the simulated mouse to complete a corresponding operation according to the touch information” further comprises: if not, exiting the one-handed operation mode.

In an embodiment, a method for one-handed operations of a mobile terminal comprises:

a. Displaying, when an instruction to turn on a one-handed operation mode is received, a simulated mouse on the touchscreen of the mobile terminal, and simultaneously displaying a simulated mouse control region within a region easily operated by a user's dominant hand on the touchscreen for controlling the simulated mouse to operate the mobile terminal;
b. Detecting a touch on the touchscreen of the mobile terminal, and acquiring position information of a touch point; and
c. Determining, according to the acquired position information of the touch point, whether the touch point is located within the simulated mouse control region, and if so, controlling the simulated mouse to complete a corresponding operation according to the touch information.

In an embodiment, the method for one-handed operations of a mobile terminal step A may include:

A1. Determining, when a user instruction to turn on a one-handed operation mode is received, whether it is a first time to turn on said one-handed operation mode; if so, go to the step A2; if no, go to the step A3;

A2. Receiving a user instruction to preset a user's dominant hand and a size of the simulated mouse control region;

A3. Displaying the simulated mouse on the touchscreen, and simultaneously displaying the simulated mouse control region within a region easily operated by a user's dominant hand on the touchscreen.

In an embodiment, the method for one-handed operations of a mobile terminal step A3 may include:

Reducing the input region of the cell phone to the size of the simulated mouse control region, and updating the boundary of each region of the simulated mouse control region according to the preset user's dominant hand.

In an embodiment, the method for one-handed operations of a mobile terminal may include:

wherein the simulated mouse control region comprises:

a movement control region for controlling movement, single click and double click operations of the simulated mouse, and for performing multi-point touch control on the region where the simulated mouse is located;

a return region for carrying out operations of the return button of the mobile terminal; and

a menu region for carrying out operations of the menu button of the mobile terminal.

In an embodiment the method for one-handed operations of a mobile terminal may include:

wherein the step C comprises:

C1. When the touch point is located within the movement control region of the simulated mouse control region, controlling the simulated mouse to complete movement, single click and double click operations according to the touch information, or performing multi-point touch control on the region where the simulated mouse is located;

C2. When the touch point is located within the return region or the menu region of the simulated mouse control region, correspondingly converting the position information of the touch point to the position information of the return button or the menu button for input into the mobile terminal, and controlling the mobile terminal to carry out a corresponding return operation or menu operation.

In an embodiment, the method for one-handed operations of a mobile terminal may include:

wherein the region easily operated by a user's dominant hand comprises: the right lower region of the touchscreen when the user's dominant hand is the user's right hand, and the left lower region of the touchscreen when the user's dominant hand is the user's left hand.

In an embodiment, the method for one-handed operations of a mobile terminal may include:

wherein the step C further comprises: when the touch point is located out of the mouse control region, exiting the one-handed operation mode.

A system for one-handed operations of a mobile terminal, may comprise:

a function activation module configured to display, when an instruction to turn on a one-handed operation mode is received, a simulated mouse on a touchscreen of the mobile terminal, and simultaneously display a simulated mouse control region within a region easily operated by a user's dominant hand on the touchscreen for controlling the simulated mouse to operate the mobile terminal;

a touch detecting module configured to detect a touch on the touchscreen of the mobile terminal, and acquire position information of a touch point;

an operation control module configured to determine, according to the acquired position information of the touch point, whether the touch point is located within the simulated mouse control region, and if so, control the simulated mouse to complete a corresponding operation according to the touch information.

In an embodiment the system for one-handed operations of a mobile terminal may include:

wherein the function activation module comprises:

a first determining unit configured to determine, when a user instruction to turn on a one-handed operation mode is received, whether it is a first time to turn on said one-handed operation mode;

a presetting unit configured to receive a user instruction to preset a user's dominant hand and a size of the simulated mouse control region; and

a function activation unit configured to display the simulated mouse on the touchscreen of the mobile terminal, and simultaneously display a simulated mouse control region within a region easily operated by a user's dominant hand on the touchscreen.

In an embodiment, the system for one-handed operations of a mobile terminal may include:

wherein the simulated mouse control region comprises:

a movement control region for controlling movement, single click and double click operations of the simulated mouse, and for performing multi-point touch control on the region where the simulated mouse is located;

a return region for carrying out operations of the return button of the mobile terminal; and

a menu region for carrying out operations of the menu button of the mobile terminal.

In an embodiment, the system for one-handed operations of a mobile terminal may include:

wherein the operation control module comprises:

a movement control unit configured to control, when the touch point is located within the movement control region of the simulated mouse control region, the simulated mouse to complete movement, single click and double click operations according to the touch information, or perform multi-point touch control on the region where the simulated mouse is located;

a return operation unit configured to convert, when the touch point is located within the return region of the simulated mouse control region, the position information of the touch point to the position information of the return button for input into the mobile terminal, and control the mobile terminal to carry out a corresponding return operation; and

a menu operation unit configured to convert, when the touch point is located within the menu region of the simulated mouse control region, the position information of the touch point to the position information of the menu button for input into the mobile terminal, and control the mobile terminal to carry out a corresponding menu operation.

In an embodiment, the present invention provides a method and system for one-handed operations of a mobile terminal. The method for one-handed operations of a mobile terminal may comprise: displaying, when an instruction to turn on a one-handed operation mode is received, a simulated mouse on the touchscreen of the mobile terminal, and simultaneously displaying a simulated mouse control region within a region easily operated by a user's dominant hand on the touchscreen for controlling the simulated mouse to operate the mobile terminal; detecting a touch on the touchscreen of the mobile terminal, and acquiring position information of a touch point; determining, according to the acquired position information of the touch point, whether the touch point is located within the simulated mouse control region, and if so, controlling the simulated mouse to complete a corresponding operation according to the touch information. The method for one-handed operations of a mobile terminal according to the present invention can limit a user input region to a region that is convenient for one-handed operation and control. The method can solve the problem of a smart mobile terminal under one-handed operation in which a blind spot is formed because the screen is too big.

### BRIEF DESCRIPTION OF THE DRAWINGS

FIG. 1 is a flow chart of an embodiment of the method for one-handed operations of a mobile terminal according to the present invention.

FIG. 2 is a schematic diagram of a simulated mouse control region when the dominant hand is the user's right hand.

FIG. 3 is a flow chart of an embodiment of the method for one-handed operations of a mobile terminal according to the present invention.

FIG. 4 is a block diagram of functions and principles of an embodiment of the system for one-handed operations of a mobile terminal according to the present invention.

### DETAILED DESCRIPTION OF THE INVENTION

The present invention will be further described in detail below with reference to the accompanying drawings and embodiments. It should be understood that the specific embodiments described herein are only used to explain the present invention, instead of limiting the present invention.

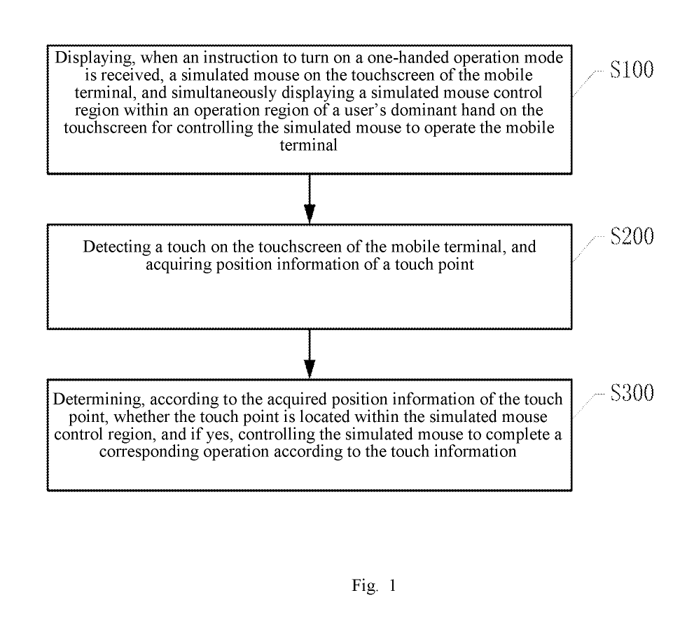

FIG. 1 is a flow chart of an embodiment of the method for one-handed operations of a mobile terminal according to the present invention. As shown in FIG. 1, the method for one-handed operations of a mobile terminal may comprise:

Step S100. Displaying, when an instruction to turn on a one-handed operation mode is received, a simulated mouse on the touchscreen of the mobile terminal, and simultaneously displaying a simulated mouse control region within a region easily operated by a user's dominant hand on the touchscreen for controlling the simulated mouse to operate the mobile terminal.

In embodiments of the present invention, a cell phone can be used as an example of the mobile terminal. To address the inconvenience in one-handed operations as a result of increased screen size, it may be necessary to reduce the input region of the cell phone, and set the input region at a position convenient for a dominant hand to contact. When a user operates the cell phone with one hand, he/she may have a habit to use one hand, a dominant hand. When the dominant hand is used to operate the cell phone, there may be a corresponding region on the touchscreen that is easy for the dominant hand to touch and operate. Namely, there may be a corresponding region in which one hand can comfortably operate. For example, when the dominant hand is the user's right hand, it may be easy to touch and operate in a right lower region of the touchscreen; and when the dominant hand is the user's left hand, it may be easy to touch and operate in the left lower region of the touchscreen. In embodiments of the present invention, the operation region of the user's dominant hand may comprise: the right lower region of the touchscreen when the user's dominant hand is the user's right hand, and the left lower region of the touchscreen when the user's dominant hand is the user's left hand.

When the present invention is implemented, a user instruction to turn on a one-handed operation mode may need to be received first to turn on the one-handed operation mode. A user may input an instruction to turn on a one-handed operation mode in various ways, which may be set to an input through buttons or switches, such as, for example, a physical button of the cell phone, or set to a touch button, such as, for example, a long-press on a certain region of the touchscreen, or through a touch gesture; in an embodiment, a double click of the Home button may enable the one-handed operation mode, for example, a user double can click the Home button to turn on the one-handed operation mode of the cell phone.

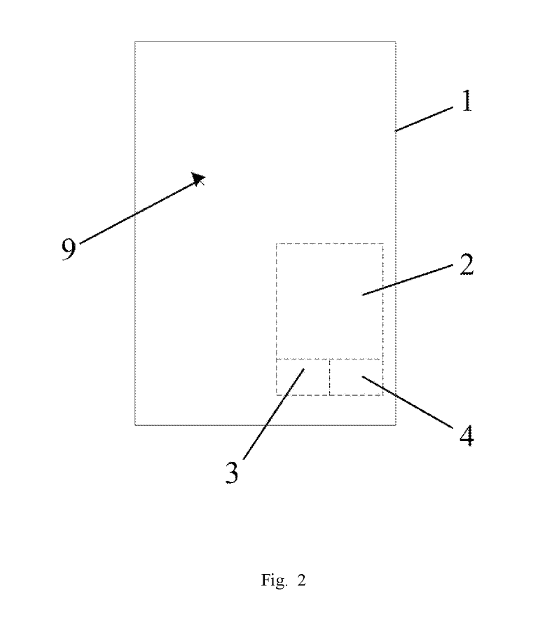

In FIG. 2, the dominant hand is shown as a user's right hand (the principle is similar for the user's left hand). After the one-handed operation mode is turned on, the cell phone first displays a simulated mouse 9 on the touchscreen 1, and at the same time, displays a simulated mouse control region within the right lower region of the touchscreen 1, which can be easy to be operated when the user's dominant hand is the user's right hand, for controlling the simulated mouse 9 to operate the cell phone. Namely, a simulated mouse control region can be plotted within the right lower region of the touchscreen, and at the same time, the terminal can be made to work in an input mode controlled by the mouse.

In FIG. 2, the simulated mouse control region may comprise: a movement control region 2 for controlling movement, single click and double click operations of the simulated mouse 9, and for performing multi-point touch control on the region where the simulated mouse 9 is located; a return region 3 for carrying out operations of the return button of the mobile terminal; and a menu region 4 for carrying out operations of the menu button of the mobile terminal. Controlling movement, single click and double click operations of the simulated mouse 9 may control the simulated mouse 9 to perform various input operations in a screen display region other than the simulated mouse control region. Performing multi-point touch control on the region where the simulated mouse 9 is located refers to performing operations, like zoom in and zoom out, on the content displayed in the region where the simulated mouse 9 is located. During an operation, the simulated mouse 9 may need to be moved to the screen display region to be operated on for positioning, and then multi-point touch control, such as zoom in and zoom out, may be performed in the movement control region 2.

The Step S100 may comprise:

Step S110. Determining, when a user instruction to turn on a one-handed operation mode is received, whether it is the first time to turn on said one-handed operation mode; if so, go to the step S120; if not, go to the step S130;

Step S120. Receiving a user instruction to preset a user's dominant hand and a size of the simulated mouse control region;

Step S130. Displaying the simulated mouse on the touchscreen, and simultaneously displaying the simulated mouse control region within a region easily operated by a user's dominant hand on the touchscreen.

In an implementation of the present embodiment, when a user instruction to turn on a one-handed operation mode is received, first determine whether it is the first time to turn on said one-handed operation mode, which is to improve the execution efficiency of the one-handed operation mode. There are certainly two scenarios: first time to turn on and non-first time to turn on. When it is the first time to turn on the one-handed operation mode, it may be necessary to preset a user's dominant hand and a size of the simulated mouse control region, which may then be saved as the default execution information (default settings). Once the one-handed operation mode has been used, presetting may be no longer necessary every time in future uses. The one-handed operation mode may be executed directly according to the default settings. When the cell phone receives a user instruction to turn on a one-handed operation mode and determines that it is not the first time to turn on the one-handed operation mode, the cell phone turns on the one-handed operation mode directly according to the preset default settings and updates the boundary of each region of the simulated mouse control region; in such a way, the presetting step is omitted and the execution efficiency is improved. When it is deemed necessary by a user, the settings that are set in advance may be revised, for example, the size of the simulated mouse control region can be adjusted to meet demands in different periods.

Step S200. Detecting a touch on the touchscreen of the mobile terminal, and acquiring position information of a touch point.

In embodiments of the present invention, when the one-handed operation mode is turned on, the cell phone may first detect a touch on the touchscreen of the cell phone, and acquire position information of a touch point. As described above, the simulated mouse control region may comprise: a movement control region 2, a return region 3 and a menu region 4. Since different regions can correspond to different control functions, acquiring position information of a touch point can confirm which region the user touches, and then correspondingly control the simulated mouse 9 to complete a corresponding operation.

Step S300. Determining, according to the acquired position information of the touch point, whether the touch point is located within the simulated mouse control region, and if so, controlling the simulated mouse to complete a corresponding operation according to the touch information.

In embodiments of the present invention, after entering the one-handed operation mode, the cell phone may intercept the touch information at the drive layer, and determine the region in which it is located by comparing the position information of the touch point. When it is determined that the touch point is located within the simulated mouse control region, the cell phone can control the simulated mouse to complete a corresponding operation according to the touch, for example, according to the touch information. There may be cases where the touch point is not located within the simulated mouse control region. Namely, although the one-handed operation mode is turned on first, the user may not touch the simulated mouse control region. It may be deemed that the user selects to temporarily exit the one-handed operation mode and shut down corresponding one-handed operation functions. In the one-handed operation mode, when clicking a portion beyond the simulated mouse control region, the cell phone can automatically exit the one-handed operation mode, and report the touch point information. The user can control the actual content displayed on the screen in said region. Therefore, the step S300 can further comprise: when the touch point is located out of the mouse control region, the cell phone exits the one-handed operation mode.

Furthermore, the Step S300 may comprise:

Step S310. When the touch point is located within the movement control region of the simulated mouse control region, controlling the simulated mouse to complete movement, single click and double click operations according to the touch information, or performing multi-point touch control on the region where the simulated mouse is located; in an implementation of the present embodiment, when the touch point is located within the movement control region of the mouse, the cell phone can transmit the touch point information to a mouse simulation drive program, and after said program determines on a movement, single click or double click event of the mouse, the cell phone can report to an Input sub-system to simulate the mouse operation event.

Step S320. When the touch point is located within the return region or the menu region of the simulated mouse control region, the mobile terminal can correspondingly convert the position information of the touch point to the position information of the return button or the menu button for input into the mobile terminal, and the mobile terminal can be controlled to carry out a corresponding return operation or menu operation. The touch operation can directly operate on the return button or the menu button of the mobile terminal, and can control the mobile terminal to complete a return operation or menu operation. In an implementation of the present embodiment, when a touch point is located within the return region or the menu region, the mobile terminal can convert the corresponding touch point to the position of a touch point corresponding to the return button or the menu button, and report to the Input sub-system.

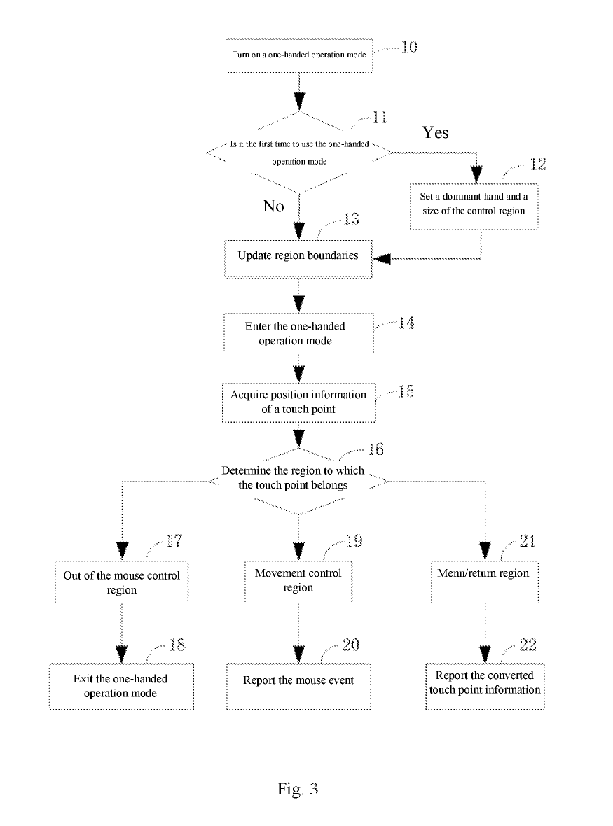

The present invention further provides an implementation of the method for one-handed operations of a mobile terminal. As shown in FIG. 3, the method for one-handed operations of a mobile terminal in the present specific implementation may comprise:

Step S10. Turn on a one-handed operation mode;

Step S11. Determine whether it is the first time to use the one-handed operation mode; if so, go to the step S12; if not, go to the step S13;

Step S12. Set a dominant hand and a size of the control region;

Step S13. Update region boundaries, for example, display the control region according to the preset size of the simulated mouse control region;

Step S14. Enter the one-handed operation mode;

Step S15. Acquire position information of a touch point;

Step S16. Determine the region to which the touch point belongs, and then enter steps S17, S19, or S21, respectively;

Step S17. When the touch point is located out of the mouse control region, enter the step S18;

Step S18. Exit the one-handed operation mode;

Step S19. When the touch point is located within the movement control region, enter the step S20;

Step S20. Report the mouse event;

Step S21. When the touch point is located within the menu/return region, enter the step S22;

Step S22. Report the converted touch point information.

The present invention may provide a method for one-handed operations of a mobile terminal, such that, after a mobile terminal enters a one-handed operation mode, a simulated mouse can be used to interact with the smart mobile terminal device to limit the user input region to a region that is easy to be operated and controlled by one hand, thereby solving the problem of the smart mobile terminal that a blind spot of one-handed operations is formed as the screen is too big.

Those skilled in the art may understand that all or a part of the steps to implement the above method embodiment may complete the setting of a touchscreen through relevant hardware as instructed by program instructions, and the program may be stored in a computer readable storage medium. During execution, the program may comprise flows of the above method embodiments. The storage medium therein may be magnetic disk, optical disk, Read Only Memory (ROM) or Random Access Memory (RAM).

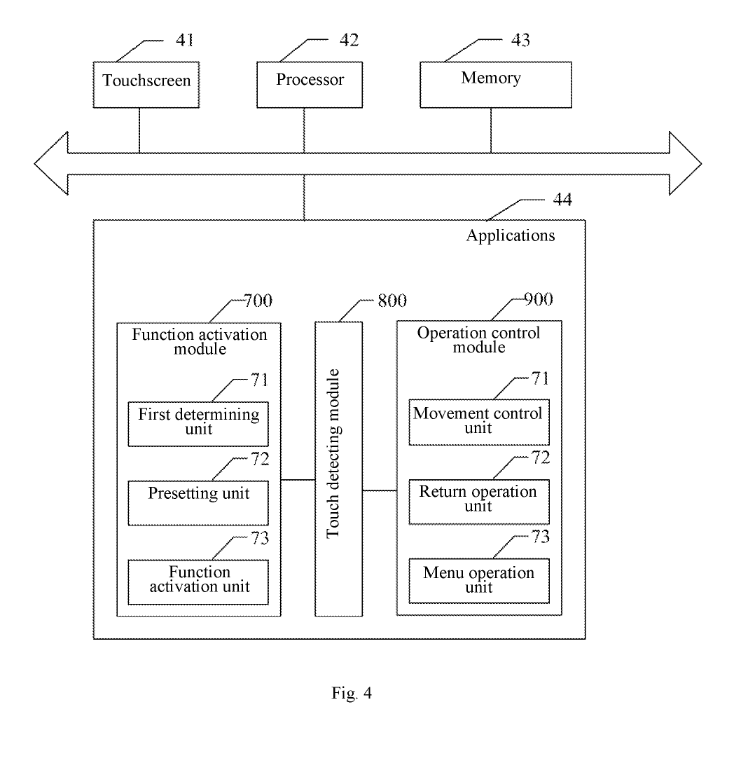

Based on the method embodiment above, the present invention may further provide a system for one-handed operations of a mobile terminal. As shown in FIG. 4, the system for one-handed operations of a mobile terminal may comprise a touchscreen 41, one or more processors 42, a memory 43, and one or more programs 44. Said one or more programs 44 may be stored in the memory 43 and configured to be executed by said processors 42, and said one or more programs 44 may comprise the following instructions so as to operate a function activation module 700, a touch detecting module 800, and an operation control module 900.

The function activation module 700 may be configured to display, when an instruction to turn on a one-handed operation mode is received, a simulated mouse on the touchscreen 41 of the mobile terminal, and simultaneously display a simulated mouse control region within an operation region of a user's dominant hand on the touchscreen 41 for controlling the simulated mouse to operate the mobile terminal.

The touch detecting module 800 can be configured to detect a touch on the touchscreen 41 of the mobile terminal, and acquire position information of a touch point.

The operation control module 900 can be configured to determine, according to the acquired position information of the touch point, whether the touch point is located within the simulated mouse control region, and if so, control the simulated mouse to complete a corresponding operation according to the touch information.

The function activation module 700 may comprise:

a first determining unit 71 configured to determine, when a user instruction to turn on a one-handed operation mode is received, whether it is the first time to turn on said one-handed operation mode.

a presetting unit 72 configured to receive a user instruction to preset a user's dominant hand and a size of the simulated mouse control region.

a function activation unit 73 configured to display the simulated mouse on the touchscreen of the mobile terminal, and simultaneously display a simulated mouse control region within an operation region of a user's dominant hand on the touchscreen.

The simulated mouse control region can comprise: a movement control region for controlling movement, single click and double click operations of the simulated mouse, and for performing multi-point touch control on the region where the simulated mouse is located; a return region for carrying out operations of the return button of the mobile terminal; and a menu region for carrying out operations of the menu button of the mobile terminal.

The operation control module 900 can comprise:

a movement control unit 91 configured to control, when the touch point is located within the movement control region of the simulated mouse control region, the simulated mouse to complete movement, single click and double click operations according to the touch information, or perform multi-point touch control on the region where the simulated mouse is located.

a return operation unit 92 configured to convert, when the touch point is located within the return region of the simulated mouse control region, the position information of the touch point to the position information of the return button for input into the mobile terminal, and control the mobile terminal to carry out a corresponding return operation.

a menu operation unit 93 configured to convert, when the touch point is located within the menu region of the simulated mouse control region, the position information of the touch point to the position information of the menu button for input into the mobile terminal, and control the mobile terminal to carry out a corresponding menu operation.

In an embodiment, the present invention provides a method and system for one-handed operations of a mobile terminal. The method for one-handed operations of a mobile terminal may comprise: displaying, when an instruction to turn on a one-handed operation mode is received, a simulated mouse on the touchscreen of the mobile terminal, and simultaneously displaying a simulated mouse control region within a region easily operated by a user's dominant hand on the touchscreen for controlling the simulated mouse to operate the mobile terminal; detecting a touch on the touchscreen of the mobile terminal, and acquiring position information of a touch point; determining, according to the acquired position information of the touch point, whether the touch point is located within the simulated mouse control region, and if so, controlling the simulated mouse to complete a corresponding operation according to the touch information. The method for one-handed operations of a mobile terminal according to the present invention may limit a user input region to a region that is convenient for one-handed operation and control, and may solve the problem of a smart mobile terminal that a blind spot of one-handed operations may be formed as the screen is too big.

It should be understood that applications of the present invention are not limited to the above examples. Those skilled in the art can make improvements or changes according to the description above, and all these improvements and changes shall be encompassed by the appended claims.

1. A method for one-handed operations of a mobile terminal, which comprises:
displaying, when an instruction to turn on a one-handed operation mode is received, a simulated mouse and a simulated mouse control region on a touchscreen of the mobile terminal, said simulated mouse control region being an operation region of a user's dominant hand formed by reducing an input region of the touchscreen, for controlling the simulated mouse to operate the mobile terminal;
detecting a touch on the touchscreen of the mobile terminal, and acquiring position information of a touch point; and
determining, according to the acquired position information of the touch point, whether the touch point is located within the simulated mouse control region, and if so, controlling the simulated mouse to complete a corresponding operation according to the touch information.

2. The method for one-handed operations of a mobile terminal according to claim 1, including
determining, when a user instruction to turn on a one-handed operation mode is received, whether it is a first time to turn on said one-handed operation mode;
if so, receiving a user instruction to preset a user's dominant hand and a size of the simulated mouse control region;
if not, displaying the simulated mouse and the simulated mouse control region on the touchscreen.

3. The method for one-handed operations of a mobile terminal according to claim 2, including:
reducing the input region of the cell phone to the size of the simulated mouse control region, and updating the boundary of each region of the simulated mouse control region according to a preset user's dominant hand.

4. The method for one-handed operations of a mobile terminal according to claim 1, wherein the simulated mouse control region comprises:
a movement control region for controlling movement, single click and double click operations of the simulated mouse, and for performing multi-point touch control on the region where the simulated mouse is located;
a return region for carrying out operations of a return button of the mobile terminal; and
a menu region for carrying out operations of a menu button of the mobile terminal.

5. The method for one-handed operations of a mobile terminal according to claim 4, including:
when the touch point is located within the movement control region of the simulated mouse control region, controlling the simulated mouse to complete movement, single click and double click operations according to the touch information, or performing multi-point touch control on the region where the simulated mouse is located;
when the touch point is located within the return region or the menu region of the simulated mouse control region, correspondingly converting the position information of the touch point to the position information of the return button or the menu button for input into the mobile terminal, and controlling the mobile terminal to carry out a corresponding return operation or menu operation.

6. The method for one-handed operations of a mobile terminal according to claim 5, including:
when the touch point is located within the movement control region of the mouse, transmitting the touch point information to a mouse simulation drive program, and after said program determines on a movement, single click or double click event of the mouse, reporting to an input sub-system to simulate the mouse operation event.

7. The method for one-handed operations of a mobile terminal according to claim 5, including:
when the touch point is located within the return region or the menu region, converting the corresponding touch point to a touch point position corresponding to the return button or the menu button, and reporting to the input sub-system.

8. The method for one-handed operations of a mobile terminal according to claim 1, wherein the operation region of a user's dominant hand comprises:
the right lower region of the touchscreen when the user's dominant hand is the user's right hand, and the left lower region of the touchscreen when the user's dominant hand is the user's left hand.

9. The method for one-handed operations of a mobile terminal according to claim 1, including:
if not, exiting the one-handed operation mode.

10. A method for one-handed operations of a mobile terminal, which comprises:
displaying, when an instruction to turn on a one-handed operation mode is received, a simulated mouse on the touchscreen of the mobile terminal, and simultaneously displaying a simulated mouse control region within a region easily operated by a user's dominant hand on the touchscreen for controlling the simulated mouse to operate the mobile terminal;
detecting a touch on the touchscreen of the mobile terminal, and acquiring position information of a touch point;
determining, according to the acquired position information of the touch point, whether the touch point is located within the simulated mouse control region, and if so, controlling the simulated mouse to complete a corresponding operation according to the touch information.

11. The method for one-handed operations of a mobile terminal according to claim 10, including:
determining, when a user instruction to turn on a one-handed operation mode is received, whether it is the first time to turn on said one-handed operation mode;
if so, receiving a user instruction to preset a user's dominant hand and a size of the simulated mouse control region;
if not, displaying the simulated mouse on the touchscreen, and simultaneously displaying the simulated mouse control region within a region easily operated by a user's dominant hand on the touchscreen.

12. The method for one-handed operations of a mobile terminal according to claim 11, including:
reducing the input region of the cell phone to the size of the simulated mouse control region, and updating the boundary of each region of the simulated mouse control region according to the preset user's dominant hand.

13. The method for one-handed operations of a mobile terminal according to claim 10, wherein the simulated mouse control region comprises:
a movement control region for controlling movement, single click and double click operations of the simulated mouse, and for performing multi-point touch control on the region where the simulated mouse is located;
a return region for carrying out operations of a return button of the mobile terminal; and
a menu region for carrying out operations of a menu button of the mobile terminal.

14. The method for one-handed operations of a mobile terminal according to claim 13, including:
when the touch point is located within the movement control region of the simulated mouse control region, controlling the simulated mouse to complete movement, single click and double click operations according to the touch information, or performing multi-point touch control on the region where the simulated mouse is located;
when the touch point is located within the return region or the menu region of the simulated mouse control region, correspondingly converting the position information of the touch point to the position information of the return button or the menu button for input into the mobile terminal, and controlling the mobile terminal to carry out a corresponding return operation or menu operation.

15. The method for one-handed operations of a mobile terminal according to claim 10, wherein the region easily operated by a user's dominant hand comprises:
the right lower region of the touchscreen when the user's dominant hand is the user's right hand, and the left lower region of the touchscreen when the user's dominant hand is the user's left hand.

16. The method for one-handed operations of a mobile terminal according to claim 15, including:
when the touch point is located out of the mouse control region, exiting the one-handed operation mode.

17. A system for one-handed operations of a mobile terminal, which comprises:
a function activation module configured to display, when an instruction to turn on a one-handed operation mode is received, a simulated mouse on a touchscreen of the mobile terminal, and simultaneously display a simulated mouse control region within a region easily operated by a user's dominant hand on the touchscreen for controlling the simulated mouse to operate the mobile terminal;
a touch detecting module configured to detect a touch on the touchscreen of the mobile terminal, and acquire position information of a touch point; and
an operation control module configured to determine, according to the acquired position information of the touch point, whether the touch point is located within the simulated mouse control region, and if so, control the simulated mouse to complete a corresponding operation according to the touch information.

18. The system for one-handed operations of a mobile terminal according to claim 17, including:
a first determining unit configured to determine, when a user instruction to turn on a one-handed operation mode is received, whether it is the first time to turn on said one-handed operation mode;
a presetting unit configured to receive a user instruction to preset a user's dominant hand and a size of the simulated mouse control region; and
a function activation unit configured to display the simulated mouse on the touchscreen of the mobile terminal, and simultaneously display a simulated mouse control region within a region easily operated by a user's dominant hand on the touchscreen.

19. The system for one-handed operations of a mobile terminal according to claim 17, wherein the simulated mouse control region comprises:
a movement control region for controlling movement, single click and double click operations of the simulated mouse, and for performing multi-point touch control on the region where the simulated mouse is located;
a return region for carrying out operations of a return button of the mobile terminal; and
a menu region for carrying out operations of a menu button of the mobile terminal.

20. The system for one-handed operations of a mobile terminal according to claim 19, including:
a movement control unit configured to control, when the touch point is located within the movement control region of the simulated mouse control region, the simulated mouse to complete movement, single click and double click operations according to the touch information, or perform multi-point touch control on the region where the simulated mouse is located;
a return operation unit configured to convert, when the touch point is located within the return region of the simulated mouse control region, the position information of the touch point to the position information of the return button for input into the mobile terminal, and control the mobile terminal to carry out a corresponding return operation; and
a menu operation unit configured to convert, when the touch point is located within the menu region of the simulated mouse control region, the position information of the touch point to the position information of the menu button for input into the mobile terminal, and control the mobile terminal to carry out a corresponding menu operation.
